(19) United States
(12) Patent Application Publication
(10) Pub. No.: US 2018/0292299 A1
(43) Pub. Date: Oct. 11, 2018

(54) METHOD OF CRITICAL DISPLACEMENT FORECAST BASED ON THE DEFORMATION FAILURE MECHANISM OF SLOPE

(71) Applicant: Hubei University of Technology, Hubei (CN)

(72) Inventors: Ying-Fa LU, Hubei (CN); De-Fu LIU, Hubei (CN)

(21) Appl. No.: 16/004,218

(22) Filed: Jun. 8, 2018

Related U.S. Application Data
(63) Continuation-in-part of application No. 14/596,025, filed on Jan. 13, 2015.

(30) Foreign Application Priority Data
Jan. 13, 2014 (CN) 201410014057.7

(51) Int. Cl. G01N 3/24; G01V 1/00; G06F 17/11; G01B 21/32; G08B 21/10

(52) U.S. Cl. CPC G01N 3/24; G01V 1/008; G08B 21/10; G01B 21/32; G06F 17/11

(57) ABSTRACT

In a method of critical displacement forecast based on the deformation failure mechanism of slope, a sliding surface displacement, a calculation based on status stability factors and a slope surface displacement are determined, and applied for forecast based on a thrust-type slope deformation mechanism, a key compartment division, a relation between stress and strain mechanics properties of sliding surface of geo-material, and an analysis of evolution characteristics at different points of the sliding surface. The method provides advantages of determining deformation values at different points of a sliding surface, a slope body and a slope surface during slope failures; describing the process of a progressive failure, deformations and force changes of a slope; combining slope monitoring values to perform the stability analysis and the calculation of the magnitude of the stability factors in different deformation statuses of the slope; and assessing the durability of protective measures to the slope.

### CROSS-REFERENCE TO RELATED APPLICATION

This application is a continuation in part of U.S. patent application Ser. No. 14/596,025, filed on Jan. 13, 2015, in the United States Patent and Trademark Office, which claims the benefit of China Patent Application No. 201410014057.7, filed on Jan. 13, 2014, in the State Intellectual Property Office of the People's Republic of China, the disclosure of which is incorporated herein in its entirety by reference.

### BACKGROUND OF THE INVENTION

### 1. Field of the Invention

The present invention relates to a slope forecast and warning technology, and more particularly to a method of critical displacement forecast based on the deformation failure mechanism of slope.

### 2. Description of the Related Art

Slope forecast is still a difficult technical problem remained to be solved properly, and the present methods for determining critical displacements of the deformation failure are still imperfect. In slope failures, displacements at different positions vary. As to different slopes, the deformation mechanism is also different. In general, the critical displacement and the critical deformation rate in the conventional slope forecast and warning did not point out the critical displacement and critical deformation rate at a particular position of the slope.

### SUMMARY OF THE INVENTION

Therefore, it is a primary objective of the present invention to provide a method of critical displacement forecast based on the deformation failure mechanism of slope, and to provides a method of determining sliding surface displacement, a calculation based on displacement status stability factors and a slope surface displacement of a slope, based on a thrust-type slope deformation mechanism, a key compartment division, a relation between stress and strain mechanics properties of sliding surface of geo-material, and an analysis of evolution characteristics at different points of the sliding surface.

To achieve the aforementioned objective, the present invention provides a method of critical displacement forecast based on the deformation failure mechanism of slope, wherein a sliding surface displacement, calculation based on a status stability factors of a displacement and a slope surface displacement are determined and applied for forecast and warning based on a thrust-type slope deformation mechanism, a key compartment division, a relation between stress and strain mechanics properties of sliding surface of geo-material, and an analysis of evolution characteristics at different points of the sliding surface.

The method of critical displacement forecast based on the deformation failure mechanism of slope of the present invention comprises the following steps:

1. Analyze fundamental morphology and characteristics of a slope by a detecting device, perform an experiment to slope body and slope surface to obtain basic physical and mechanical parameters G, S, m, ρ, C, φ, a₁, a₂, a₃, and ξ_{N} of a sliding surface and a sliding body.

2. Substitute the parameters obtained from Step (1) into the Equation τ=Gγ[1+γ^{m}/S]^{ρ} by a computing device, where τ and γ are a shear stress and a shear strain of a material respectively, τ and G are in a unit of MPa or kPa or Pa, and S, m and ρ are parameters with no unit, and −1<ρ≤0 and 1+mρ≠0. Wherein, a critical stress space τ^{peak} is described by the Mohr-Coulomb Criteria τ^{peak}=C+σₙ tan φ, wherein C is cohesion, σₙ is normal stress, C and σₙ are in unit of MPa, kPa or Pa, and φ is sliding-surface friction angle, and a critical strain space γₚₑₐₖ is described by the Equation (γₚₑₐₖ/a₃)²+((σₙ−a₂)/a₁)^{ξ}_{N}=1, in which σₙ is normal stress in unit of MPa, kPa or Pa, and a₁, a₂, a₃ and ξ_{N} are the constant coefficients; the critical stress space and the critical strain space have a relation of τ^{peak}/γₚₑₐₖ=G[1−1/(1+mρ)]^{ρ}, and the critical strain space complies with the equation of S+(1+mρ)γ^{m}ₚₑₐₖ=0; the parameter ρ=ρ₀/(1+(ρ₀/ρ_{c}−1)(σₙ/σₙ^{c})^{ξ}), in which ρ₀ is the value that the normal stress (σₙ) is zero, ρ_{c} is the value that σₙ is equal to σₙ^{c}, and ξ is constant.

3. Calculate the displacement at different points of the sliding surface by the computing device by using the critical strain space at the different points of the sliding surface obtained from Step (2).

4. Calculate the stress field of the sliding surface and the sliding body produced by the corresponding strain change by the computing device by using the displacement at the different points of the sliding surface obtained from Step (3), and calculate a corresponding strain field and a corresponding stress field during the slope failure to obtain a displacement value at the failure of the sliding surface, which is equal to a displacement value of the different points of the sliding surface during the slope failure, and use the physical and mechanical parameters of the slide body to calculate different displacement values of the slope body and slope surface.

5. Perform a feedback forecast and warning by obtaining the displacement values at different points of the sliding surface from a reverse calculation by using a measured data of the slope body and the slope surface.

A status stability factor Fₛ is calculated by the stability factors obtained from Step (1), in which a displacement vector sum S_{c-t} at a whole failure of the slope is divided by a displacement vector sum Sₚ₋ₜ measured at a status state, and the stability factors exist in three directions of the X-axis, Y-axis and Z-axis are Fₛ₋ₓ=S_{c-t}^{x}/Sₚ₋ₜ^{x}, F_{s-y}=S_{c-t}^{y}/Sₚ₋ₜ^{y}, and F_{s-z}=S_{c-t}^{z}/Sₚ₋ₜ^{z} respectively.

The displacement values of the slope body and slope surface is calculated by obtaining a variation relation Sₘ from the sliding surface displacement and the slope surface displacement by applying a monitoring data analysis in situ, and the variation relation Sₘ is represented by a height (h) related parabolic curve Sₘ=Sᵢ+b₂h+b₃h², wherein b₂ and b₃ are constant coefficients, so as to obtain the displacement values of the slope body and slope surface.

The detecting device may include an inclinometer, a displacement meter and a force sensor.

The method of critical displacement forecast based on the deformation failure mechanism of slope in accordance with embodiments of the present invention has the following advantages and effects:

1. The method may determine the deformation values at different points of a sliding surface, a slope body and a slope surface in a slope failure.

2. The method may describe the process of a progressive failure, deformations and force changes of a slope.

3. The method may combine the conventional slope monitoring values to perform the stability analysis and calculation of the magnitude of the stability factors of the slope at different deformation states.

4. The method may combine a deformation history to assess the durability of protective measures to a slope.

### BRIEF DESCRIPTION OF THE DRAWINGS

FIG. 1 is a schematic view showing the process of progressive failure and evolution of a slope;

FIG. 2, part (a) is a characteristic curve of an evolution at different points of a sliding surface in a specific time period;

FIG. 2, part (b) is a curve of load-displacement, mechanical classification and stable status of a sliding surface of a slope;

FIG. 2, part (c) is a curve of deformation at different points in the same period;

FIG. 2, part (d) is a curve of evolution of a progress slope failure at a specific time period;

FIG. 3 is a time characteristic curve of a sliding surface;

FIG. 4 is a time characteristic curve of different points of a sliding surface at the time approaching the failure; and

FIG. 5 is a displacement relation curve of a two-dimensional sliding surface.

FIG. 6 is a system block diagram of performing the method of critical displacement forecast.

FIG. 7 is a drawing of a loess landslide with a water level distribution.

FIG. 8 is slice block diagram of progressive failure process of loess landslide.

Wherein, T is a load, T^{peak} is a load at peak, T^{yield} is a load at yield limit, T^{resid} is a residual load, P^{peak} is a load point at peak, P^{yield} is a load point at yield limit, P^{resid} is a residual load point, Pₐ, P_{b} and P_{c} are different load points; S is a displacement, S^{peak} is a displacement at peak point, S^{yield} is displacement at yield limit point, S^{yield} is a displacement at residual point, H is height, and t is time.

### DETAILED DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and same numerals are used to represent respective elements in the preferred embodiments. It is intended that the embodiments and drawings disclosed herein are to be considered illustrative rather than restrictive. Same numerals are used for representing same respective elements in the drawings.

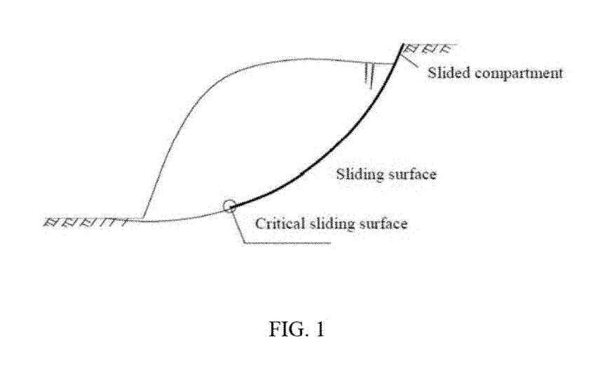

In a deformation mechanism of a thrust-type slope, the thrust-type slope generally cracks or breaks at a posterior end first. As time goes by and washing by rain with the evolution of geo-material strength, the cracking surface gradually moves from top to bottom. The middle of the slope will be uplifted and bulged after the deformation is accumulated to a specific level. At specific time, the front of the slope will be of failure, and finally the whole slope will be of failure. In the whole evolution process, the slope has only one point (or one curve) in a two-dimensional plane (or a three-dimensional plane) of the sliding surface of the slope is situated at a peak stress status (which is the critical stress status) and the remaining points are situated at a residual stress status or a status before the peak stress status. The progressive failure evolution process of the slope is shown in FIG. 1.

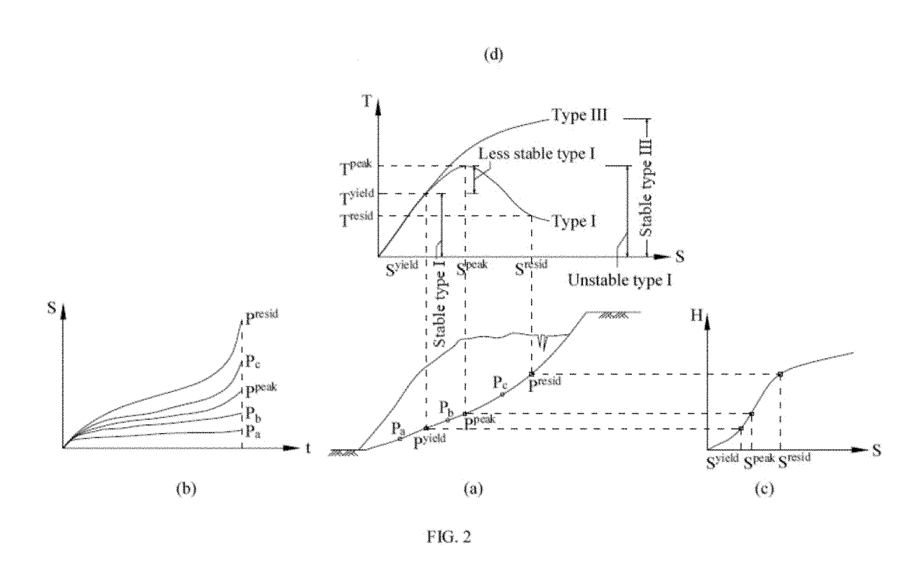

In the compartment division of a slope at different statuses, the physical and mechanical properties of a sliding surface of the slope comply with the curve characteristics of the load and displacement of geo-materials. Thus, it is necessary to categorize the stabilities of a slope compartment at different stages. If the load-displacement relation curve of a slope compartment is situated at a Type I status and the compartment is situated at a status before the load at yield limit, then the compartment will be defined as stable. If the compartment is situated at a status between the load at the yield limit and the peak load, then the compartment will be defined as lack-of-stability. If the compartment is situated at a status after the peak load, then the compartment will be defined as unstable. If the load-displacement relation of the compartment is situated at a Type III status, the compartment will be defined as stable. Please refer to FIG. 2, part (d) for a division of the stabilities of the slope compartment. According to the division of the stabilities of the slope compartment, the key compartments are the compartment situated at a load status before a yield limit and the compartment showing a Type III characteristic in the load-displacement relation curve of the slope compartment. The key compartments of a slope in situ are the compartments with a very small deformation at a sliding-resisting section and the compartment located at an anti-warping section at the front of the slope, etc.

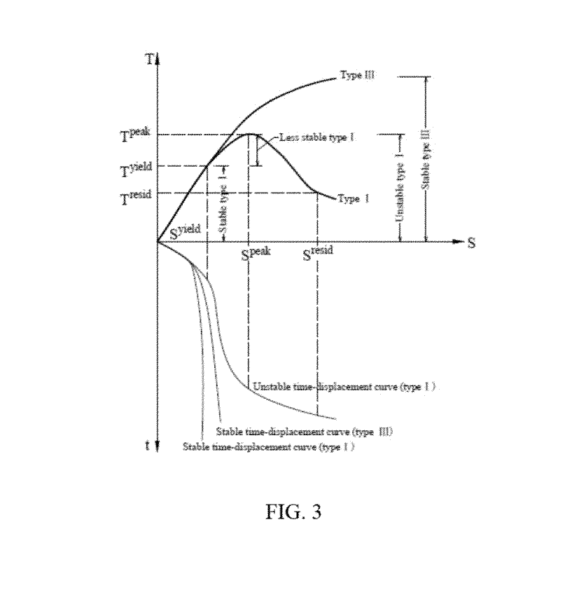

In the division of time and deformation characteristic curve, the division of the compartments obviously shows that the mechanical properties of the compartment not just relate to the stress status where the compartment is located only, but also relate to the deformation status of the compartment. Therefore, the deformation of slope and the transmission of forces are closely correlated and indispensable to each other. As to every point on the sliding surface of the slope, the time and displacement relation curve complies with the mode as shown in FIG. 3. If the point of a sliding surface is situated at a Type I status and has gone through the Type I stable status, lack-of-stability status and unstable status, such point will show the characteristics of a type I unstable curve. If the point of a sliding surface is situated at the Type I status and has just gone through the Type I stable status, such point will show the characteristics of a Type I stable curve. If the point of a sliding surface is situated at a Type III status, such point will show the characteristics of a Type III stable curve. These characteristics are related to the characteristics of the load-displacement curve of the geo-materials.

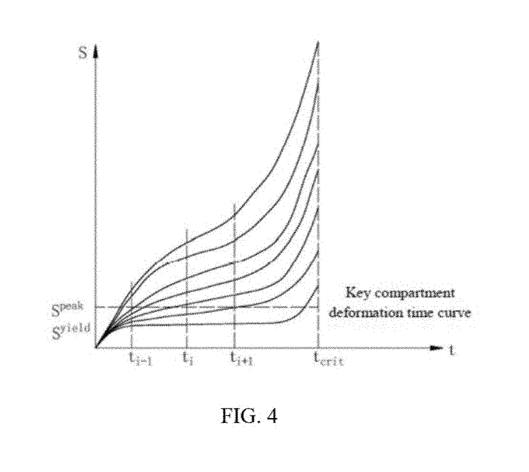

As to the evolution characteristics of time and displacement at different points of a slope, the different points on the sliding surface of the slope comply with the characteristics of the curve at a specific time as shown in FIG. 3, so that the whole sliding surface will comply with the characteristics of the time curve. In other words, different points on the sliding surface comply with the characteristics of the curve at the same time period as shown in FIG. 2, part (c). In the time period t₁, different points (such as Pₐ, P_{b}, P^{peak}, P_{c}, and P^{resid}) will comply with the characteristic of the curve as shown in FIG. 2, part (a). In a progressive changing process as shown in FIG. 2, part (a), the critical status point of the sliding surface is evolved from top to bottom. In the process of a slope failure, each point has experienced the critical status. A point exists in the sliding surface, and after such point (or a curve) has experienced the critical status, the whole slope will be failed. The compartment corresponding to this point (or curve) is called a key compartment, and the displacement corresponding to the key compartment is called a critical displacement. If a slope is about to have a failure, the time curve at different points of the sliding surface will show the characteristics as shown in FIG. 4. If the measurements are taken at different time points (such as tᵢ₋₁, tᵢ, and tᵢ₊₁), the curve characteristics of time and displacement will comply with the characteristics of the evolution occurred after that time period as shown in FIG. 4.

The method of critical displacement forecast based on the deformation failure mechanism of slope of the present invention comprises the following steps:

1. Analyze fundamental morphology and characteristics of a slope by a detecting device, perform an experiment to obtain basic physical and mechanical parameters G, S, m, ρ, C, φ, a₁, a₂, a₃, and ξ_{N} of a sliding surface and a sliding body, calculate a displacement field and a stress field, and determine a stability factors by the stress field.

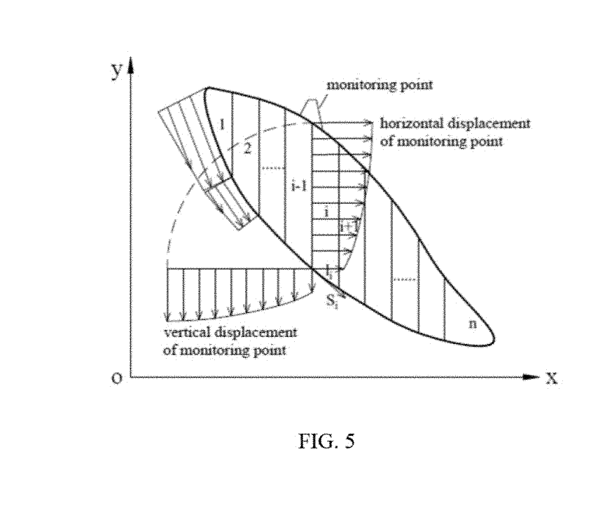

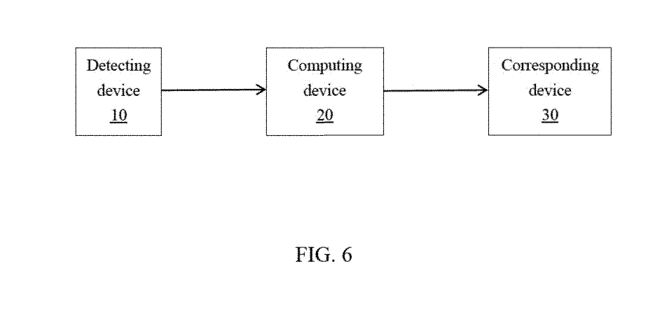

As shown in FIG. 6, the detecting device 10 may include the inclinometer, the displacement meter and the force sensor. The inclinometer detects the tilt angle of the slope and the detecting results can be transferred to the computing device 20 by an electrical signal or message. The displacement meter measures the displacement structure of the slope or inside the rock, so that the stress and strain parameters can be reflected and collected. The force sensor determines the pressure of the specific location. The detecting data may be sent to the computing device for calculating the parameters of the stress-strain model. Referring to FIG. 5, when the certain section of the surface in the monitoring point shows that the displacement is discontinuous, the detecting data may sent to the computing device 20 and determines that the section is in destruction state. When the displacement is continuous, the section may be in the peak state or before the peak state. Thus, the critical state can be determined accordingly. In addition, the force sensor may use the pressure box (like steel string pressure box or oil chamber pressure box) to determine the press force at the certain point of the surface, so as to determine the critical state.

2. Substitute the parameters obtained from Step (1) into the Equation τ=Gγ[1+γ^{m}/S]^{ρ} by the computing device, where τ and γ are a shear stress and a shear strain or a shear-like stress and a shear-like strain of a material, respectively. G is the shear modulus dependent on the normal stress. τ and G are in a unit of MPa or kPa or Pa, and S, m and ρ are parameters without unit dependent on the normal stress, and −1<ρ≤0 and 1+mρ≠0. The critical strain (the critical strain is defined as that correspondent to the peak stress) is satisfied in the form: S+(1+mρ)γₚₑₐₖ^{m}=0, where γₚₑₐₖ is the strain correspondent to the critical stress.

The computing device 20 includes at least one processor and the memory. The computing device also has the input and outputinterface. The input interface may be a terminal to receive the data detected by the detecting device. For example, the terminal can be an input device like a touch screen or a keyboard, or the terminal can be a data receiver. The measured data can be input and saved in the memory, like a hard drive disk, flash memory. The memory also stored the stress-strain model and the instructions to drive the processor for performing the following steps

A critical stress space τ^{peak} is described by the Mohr-Coulomb Criteria, τ^{peak}=C+σₙ tan φ, wherein C is cohesion, σₙ is normal stress, C and σₙ is in unit of MPa, kPa or Pa, and φ is sliding-surface friction angle, or other criteria are adopted.

A critical strain space γₚₑₐₖ is described by the Equation (γₚₑₐₖ/a₃)²+((σₙ−a₂)/a₁)^{ξ}_{N}=1, wherein a₁, a₂, a₃ and ξ_{N} are constants coefficients dependent on the normal stress, σₙ is normal stress in the unit of MPa, kPa or Pa. In addition, G=G₀+b₁ σₙ+b₂σₙ², where G₀ is tha initial shear modules when the normal stress (σₙ) is equal to zero and b₁ is constant coefficient without unit, and b₂=−b₁/(2 a₂).

The critical stress space and the critical strain space have a relation of τ^{peak}/γₚₑₐₖ=G[1−1/(1+mρ)]^{ρ}, and the critical strain space complies with the equation S+(1+mρ)γ^{m}ₚₑₐₖ=0. Wherein, the parameter ρ=ρ₀/(1+(ρ₀/ρ_{c}−1)(σₙ/σₙ^{c})^{ξ}), ρ₀ is the value that the normal stress (σₙ) is equal to zero, ρ_{c} is the value that the σₙ is equal to σₙ^{c}, and ζ is constant. The softening equation can be obtained by the shear stress and strain tests with the different normal stress. The four parameters can be determined by experiments. The sample of the rock or soil mass is taken from the field by using the detecting device and the complete process of shear stress and strain are conducted in laboratory or field. The peak shear stress is used to determinate the cohesion and frictional angle relative to the Mohr Coulomb criteria, the parameters are calibrated by the critical strain correspondent to the peak stress.

3. The displacement at different points of the sliding surface is calculated by the computing device by using the critical strain space at the different points of the sliding surface obtained from Step (2).

4. The displacements at the different points of the sliding surface obtained from Step (3) may be used to calculate a corresponding strain field and a corresponding stress field through the computing device, and this calculation may be conducted till the slope failure. The stability factors provided by the present invention may be used to obtain the displacement values at the failure of the sliding surface (which are the displacement values at different points of the sliding surface in a slope failure). In the meantime, the physical and mechanical parameters of the slide body may be used to calculate different displacement values of the slope body and slope surface. The measured data of the slope body and slope surface may be used to obtain the failure and displacement values of different points of the slope surface.

The method of the present invention may use a measured value of the current slope for a reverse calculation to determine the current critical unit or critical compartment so as to perform a feedback forecast and warning. The feedback forecast and warning can be sent to the corresponding device 30 through the output interface. The corresponding device 30 may be the computer server, the handheld device or the alarm device. The alert notification can be a message or ringtone for reminding people the slope condition.

The status stability factor Fₛ is calculated by dividing the displacement vector sum S_{c-t} measured at the whole failure of the slope by the displacement vector sum Sₚ₋ₜ measured at the status state, and the stability coefficients exist in three directions of the X-axis, Y-axis and Z-axis are Fₛ₋ₓ=S_{c-t}^{x}/Sₚ₋ₜ^{x}, F_{s-y}=S_{c-t}^{y}/Sₚ₋ₜ^{y}, and F_{s-z}=S_{c-t}^{z}/Sₚ₋ₜ^{z}, respectively.

As to the method of determining the displacements of the slope body and the slope surface, conventional numerical analysis may be adopted; particularly, a method of determining the boundary of a sliding surface disclosed in embodiments of the present invention may be adopted. Data measured in situ may also be used for the determination. For example, a inclinometer may be used to detect a variation relation Sₘ from the sliding surface and the slope surface displacement, and such relation can be described by using a height h related parabolic curve Sₘ=Sᵢ+b₂h+b₃h².

The extended constitutive model is presented as follows: (1) the stress-strain equation, (2) the peak stress criteria (for instance: Mohr coulomb, Drucker Preger etc.), (3) the critical strain criteria, (4) the shear modulus equation, (5) the evaluation equation of softening coefficient.

The different criterion has been proposed for the rock and soil mass, the Mohr coulomb criterion is employed in the present embodiment, the curve characteristics of the Mohr coulomb criterion is a linear for two-dimensional mechanical behaviors, the horizontal and vertical axis are presented the normal stress and shear stress respectively, the value of intersection point between the Mohr coulomb criterion and the vertical axis presents the cohesion (C), the inclination of the Mohr coulomb criterion shows the frictional angle of geo-materials.

The relationship between the critical strain and normal stress is defined as the critical strain equation, the critical strain is correspondent to the critical stress. The elliptic equation is obtained by the equation (γₚₑₐₖ/a₃)²+((σₙ−a₂)/a₁)^{ξ}_{N}=1 mentioned above. The normal stress (σₙ) is taken as a horizontal axis, the vertical axis is presented as a the critical shear strain (γₚₑₐₖ), the semi-axis length of the horizontal and vertical axis is the a₁ and a₃ respectively, the a₂ unit of the elliptic center is moved forward the positive horizontal axis, the co-ordinate of E point is (a₂, 0). The physical significance of each parameter a₂ is the critical normal stress (when the normal stress is greater the a₂, the hardening mechanical behaviors are shown); a₃ is the strain when the normal stress is equal to the critical normal stress (a₂); a₁ describes the critical shear strain when the normal stress is equal to zero. In addition, the other embodiment can provide parabolic equation for the critical shear strain.

The shear modulus equation is obtained by the equation G=G₀+b₁σₙ+b₂σₙ², when σₙ=0, the shear modulus is G₀, when ∂G/∂σₙ=0, the shear modulus is correspondent to the critical normal stress. Thus, the evaluation of shear modulus can be presented.

The equation ρ=ρ₀/(1+(ρ₀/ρ_{c}−1)(σₙ/σₙ^{c})^{ξ}) can be described the characteristics of softening coefficient, the value of softening coefficient is changeable from 0 to −1. The more small the value of the softening coefficient is, the higher the softening degree of rock and soil is, the value of softening coefficient is near to zero, the mechanical behaviors of perfect elasto-plastic model will be gotten.

The function of the extended constitutive model is strong, and can be describe the mechanical behaviors of most geological materials, the classification of mechanical behaviors of most geological materials can be presented under the changeable and constant shear modulus as follows: (1) elastic fragile mechanical behavior (EFM), (2) perfect elasto-plastic mechanical behavior (PEPM), (3) softening mechanical behavior, (4) hardening mechanical behavior. The extended constitutive model can be described the above mechanical behaviors. The traditional some model may be presented as a special case of the extended constitutive model.

The post-failure mechanical behavior after the peak stress is consistent of the material nature and structure properties, such as: slip, opening, relaxing, filling etc. The definition of strain in the zone of post-failure must be changed, and is the sum of the material nature and other deformation per unit length, which is different to the traditional strain.

The extended constitutive model in this paper is suitable to describe the fundamental mechanical properties of rock and soil, it presents the mechanical behaviors with not only the constant shear modulus, but also the changeable shear modulus and it is very easy to generalize the extended constitutive model to the non-saturated mechanical behaviors.

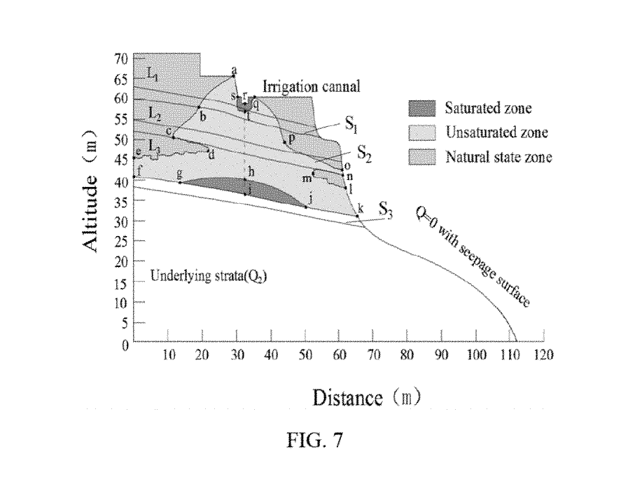

As shown in FIG. 7, a drawing of a loess landslide with a water level distribution is provided. The sedimentary loess (L₁-L₃) and loess layers (S₁-S₃) provide different void ratio (e) and permeability coefficients (kᵥ(cm/s)) as followed table.

TABLE 1

| layers | L₁ | S₁ | L₂ | S₂ | L₃ | S₃ |
|---|---|---|---|---|---|---|
| e | 1.278 | 0.890 | 1.078 | 0.842 | 1.042 | 0.615 |
| kᵥ | 15.8 × | 8.3 × | 11.8 × | 7.8 × | 7.2 × | 1.5 × |
| | 10⁻⁴ | 10⁻⁵ | 10⁻⁴ | 10⁻⁵ | 10⁻⁴ | 10⁻⁶ |

According to table 1, the permeability coefficients are bigger in layers (L₁-L₃) and the layer S₃ has the small permeability coefficient. It can be considered as an impervious layer. The water is likely to accumulate on the layer L₃. The loess layers (L₁-L₃) are loose, the void ratio is greater than 0.900, and the paleosol layer is relatively dense, with a porosity of less than 0.720. Compared with the liquid limit and saturated water content, the saturation moisture content of the loess layer is higher than the liquid limit, which means that when the saturated loess is subjected to a certain water pressure, it is easily damaged.

The strength parameters are often determined by triaxial tests and shear tests. The number of saturation and non-saturation processes has historically been experienced. However, the landslides have not been destroyed. Therefore, the main cause of the landslide damage is farmland irrigation. The water pressure generated by the water seepage in the water channel, which causes the landslide to be destroyed. Water is the key factor causing the instability of the landslide. In addition, most of the landslides are in the layer L₃, and the hydraulic characteristics of the layer L₃ are mainly studied.

The corresponding shear stress constitutive model parameters are obtained by the similar method of the above embodiment, wherein b₁=b₂=0, G₀=16800 (kPa), a₁=9.9×10⁻³, a₁=5.21×10⁻⁵, σₙ^{c}=600 (kPa), ρ₀=−0.5, ξ=600. Back to FIG. 7, the regions (rstq and gijh) are saturated regions, while the region (sabcdefghjklmnopqt) is unsaturated, and the rest are natural state regions. The initial height of the dam (hi) is approximately 5 meters, and the height of the channel (ti) is approximately 20 meters. Using the undisturbed soil strength parameters of the loess landslide and taking the ratio of tensile strength to pressure, when the head is 5 meters, the shear failure occurs at the first 20 meters below the saturated area of the irrigation channel (located on the layer L₃). According to the Mohr-Coulomb Criteria, the angle of destruction is 60° with the horizontal.

For the two-dimensional problem, the stress of the bar can be obtained according to the above calculation, so that the corresponding principal stress can be calculated. Using the Mohr-Coulomb Criteria, the angle between the shear stress plane and the minimum principal stress when the unit is destroyed can be determined. The rotation angle of the principal stress relative to the vertical direction determines the angle of rotation of the sliding surface relative to the horizontal plane.

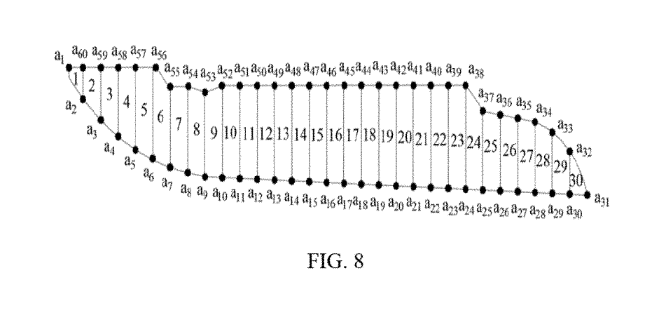

Please refer to FIG. 8, which shows a slice block diagram of progressive failure process of loess landslide. According to the above analysis, the landslide was first sheared and destroyed at the bottom of the 7th block, and the line of destruction was 60° from the horizontal axis. Since the critical shear strain required for the failure of the 7th block is 0.071, the shear strain causes the 1st to 7th blocks to immediately undergo tensile shear failure. At this time, the 1st to 7th blocks become the post-destruction zone, and the trailing type is converted to shift type, pushing the bar in front of the 7th to move forward, resulting in the 8th block in a critical state. The horizontal and vertical displacements of the first block at this time are: 13 cm and 80 cm. As the displacement increases, the critical state bar moves forward little by little.

When the 20th block is a critical state, the horizontal and vertical displacement of the first block is respectively 52 cm and 312 cm. At this time, the 21st to 30th blocks are also in the state of post-destruction. When the 20th block is in a critical state, the required strain for this block is: 0.241, and this strain must also cause blocks 21 to 30 to be in the state of post-destruction. However, the sliding force of the blocks 28, 29, and 30 is greater than the frictional resistance, and the 27th block is equal to the frictional resistance, that is, the 27th block is also a critical state block. As the deformation increases, when the 22nd block is in a critical state, the other blocks are in the state of post-destruction, and the sliding force is greater than the frictional resistance. At this time, the entire landslide is in mechanical destruction, resulting in the overall destruction of the landslide.

Based on the above embodiment, the present disclosure may determine the fundamental morphology and characteristics of a slope. The detecting and monitoring of the slope can be provided to perform the feedback forecast or the warning message. The disclosed model can also applied on the different situation of the slope, like adding the effect from the water. Therefore, the present disclosure is suitable for providing the correct and timely slope forecast and warning.

What is claimed is:

1. A method of critical displacement forecast based on the deformation failure mechanism of slope, comprising the steps of:
(1) analyzing fundamental morphology and characteristics of a slope by a detecting device, performing an experiment to slope body and slope surface to obtain basic physical and mechanical parameters G, S, m, ρ, C, φ, a₁, a₂, a₃, and ξ_{N} of a sliding surface and a sliding body;
(2) substituting the parameters obtained from Step (1) into the Equation τ=Gγ[1+γ^{m}/S]^{ρ} by a computing device, where τ and γ are a shear stress and a shear strain of a material respectively, τ and G are in unit of MPa or kPa or Pa, and S, m and ρ are parameters with no unit, and −1<ρ≤0 and 1+mρ≠0;
wherein a critical stress space τ^{peak} is described by the Mohr-Coulomb Criteria, τ^{peak}=C+σₙ tan φ, wherein C is cohesion, σₙ is normal stress, C and σₙ is in unit of MPa, kPa or Pa, and φ is sliding-surface friction angle;
wherein a critical strain space γₚₑₐₖ is described by the Equation (γₚₑₐₖ/a₃)²+((σₙ−a₂)/a₁)^{ξ}_{N}=1, wherein σₙ is normal stress in unit of MPa, kPa or Pa, wherein a₁, a₂, a₃ and ξ_{N} are constants coefficients;
wherein the critical stress space and the critical strain space have a relation of τ^{peak}/γₚₑₐₖ=G[1−1/(1+mρ)]^{ρ}, and the critical strain space conforms with the equation of S+(1+mρ)γ^{m}ₚₑₐₖ=0;
wherein the parameter ρ=ρ₀/(1+(ρ₀/ρ_{c}−1)(σₙ/σₙ^{c})^{ξ}), in which ρ₀ is the value that the normal stress σₙ is equal to zero, ρ_{c} is the value that the σₙ is equal to σₙ^{c}, and ξ is constant;
(3) calculating the displacement at different points of the sliding surface by the computing device by using the critical strain space at the different points of the sliding surface obtained from Step (2);
(4) calculating the stress field of the sliding surface and the sliding body produced by the corresponding strain change by the computing device by using the displacement at the different points of the sliding surface obtained from Step (3), and calculating a corresponding strain field and a corresponding stress field during the slope failure to obtain a displacement value at the failure of the sliding surface, which is equal to a displacement value of the different points of the sliding surface during the slope failure; and using the physical and mechanical parameters of the slide body to calculate different displacement values of the slope body and slope surface; and
(5) performing a feedback forecast and warning by obtaining the displacement values at different points of the sliding surface from a reverse calculation by using a measured data of the slope body and the slope surface.

2. The method of critical displacement forecast based on the deformation failure mechanism of slope as claimed in claim 1, wherein a status stability factor Fₛ is calculated by the stability factors obtained from Step (1), in which a displacement vector sum S_{c-t} at a whole failure of the slope is divided by a displacement vector sum Sₚ₋ₜ measured at a status critical state, and the stability factors exist in three directions of the X-axis, Y-axis and Z-axis are Fₛ₋ₓ=S_{c-t}^{x}/Sₚ₋ₜ^{x}, F_{s-y}=S_{c-t}^{y}/Sₚ₋ₜ^{y}, and F_{s-z}=S_{c-t}^{z}/Sₚ₋ₜ^{z} respectively;
wherein a point exists in the sliding surface, and after the point has experienced the critical status, the whole slope will be failed.

3. The method of critical displacement forecast based on the deformation failure mechanism of slope as claimed in claim 1, wherein the displacement values of the slope body and slope surface in the step (4) is calculated by obtaining a variation relation Sₘ from the sliding surface displacement and the slope surface displacement by using a monitoring data analysis in situ, and the variation relation Sₘ is represented by a height related parabolic curve Sₘ=Sᵢ+b₂h+b₃h², wherein b₂ and b₃ are constant coefficients, so as to obtain the displacement values of the slope body and slope surface.

4. The method of critical displacement forecast based on the deformation failure mechanism of slope as claimed in claim 1, wherein the detecting device comprises an inclinometer, a displacement meter and a force sensor.
